(19) United States
(12) Patent Application Publication
(10) Pub. No.: US 2011/0002312 A1
(43) Pub. Date: Jan. 6, 2011

(54) COMMUNICATION METHOD AND CELL STATION USING THE SAME

(75) Inventors: Nobuhiro Masaoka, Gifu (JP); Sakiko Nakamura, Gifu (JP)

Correspondence Address: Studebaker & Brackett PC, One Fountain Square, 11911 Freedom Drive, Suite 750, Reston, VA, 20190, US

(73) Assignee: KYOCERA CORPORATION, Kyoto (JP)

(21) Appl. No.: 12/920,939

(22) PCT Filed: Mar. 5, 2009
(86) PCT No.: PCT/JP2009/054157

§ 371 Date: Sep. 3, 2010

(30) Foreign Application Priority Data
Mar. 6, 2008 (JP) 2008-056687

(51) Int. Cl. H04J 3/00

(52) U.S. Cl. 370/336

(57) ABSTRACT

A radio controller, which prescribes repetition of a frame formed by a plurality of downlink time slots and a plurality of uplink time slots, and which allocates a first data to be broadcast and a second data to be transmitted to a personal station with switching to the downlink time slots corresponding to each other in each frame. Further, the radio controller allocates a third data, which should be received from the personal station, to the uplink time slot corresponding to the downlink time slot allocated to the first data and to the uplink time slot corresponding to the downlink time slot allocated to the second data.

A RF unit, a baseband processor, and a modulator/demodulator transmit the allocated first and second data. Further, the RF unit, the baseband processor, and the modulator/demodulator receive the allocated third data.

### TECHNICAL FIELD

The present invention relates to communication technology, specifically, to a communication method of allocating a channel to a personal station and a cell station using the same.

### BACKGROUND

In the mobile communication systems such as second generation cordless telephone systems, a logical control channel (hereinafter, referred to as “LCCH”) is prescribed. A cell station (CS) performs communication by allocating a time slot acting as a unit of communication to personal stations (PSs). A related LCCH, when the number of divided groups is eight, is configured of a total of 12 channels including a broadcast control channel (hereinafter, referred to as “BCCH”), eight paging channels (hereinafter, referred to as “PCH”), and three signaling control channels (hereinafter, referred to as “SCCH”). The cell station intermittently transmits each channel at intervals of 20 frames (e.g. see non-patent literature 1). Further, one frame is configured of eight time slots.

[Non-patent Literature 1] ARIB STANDARD RCR STD-28-1 “Second Generation Cordless Telephone System Standard” Version 4.1 (1/2)

### DISCLOSURE OF THE INVENTION

### Problems that the Invention is to Solve

Eight time slots included in one frame are classified into four time slots for an uplink and four time slots for a downlink. In the second generation cordless telephone system, a cell station allocates the time slots to personal stations using an LCCH. Then, the cell station allocates the time slots for the uplink and the time slots for the downlink to the personal station so as to be equal in number. That is, symmetric up-down link communication is performed between the cell station and the personal stations. Meanwhile, to stream moving image data etc. to a plurality of personal stations, broadcasting from the cell station can improve transmission efficiency, compared to performing above-mentioned communication. For example, the cell station holds one downlink time slot for the broadcasting, and broadcasts the moving image data using the downlink time slot. As a result, an uplink time slot corresponding to the downlink time slot is left behind without being used. In view of improving the transmission efficiency, it is preferable to use this uplink time slot.

The present invention has been made according to these situations, and an object of the present invention is to provide communication technology for effective using an uplink channel corresponding to a downlink channel used for broadcasting.

### Means for Solving the Problems

In order to solve the situations, a cell station in an aspect of the present invention comprising: an allocation unit, which prescribes repetition of a frame formed by a plurality of downlink time slots and a plurality of uplink time slots, and which allocates a first data to be broadcast and a second data to be transmitted to a personal station with switching to the downlink time slots corresponding to each other in each frame; and a communication unit that transmit the first and second data allocated by the allocation unit, wherein the allocation unit allocates a third data, which to be received from the personal station, to the uplink time slot corresponding to the downlink time slot allocated to the first data and to the uplink time slot corresponding to the downlink time slot allocated to the second data, and wherein the communication unit receives the third data allocated by the allocation unit.

According to another aspect of the present invention is communication method. This method comprising: a step of prescribing repetition of a frame formed by a plurality of downlink time slots and a plurality of uplink time slots, and allocating a first data to be broadcast and a second data to be transmitted to a personal station with switching to the downlink time slots corresponding to each other in each frame; a step of transmitting the allocated first and second data; a step of allocating a third data, which to be received from the personal station, to the uplink time slot corresponding to the downlink time slot allocated to the first data and to the uplink time slot corresponding to the downlink time slot allocated to the second data; and a step of receiving the allocated third data.

Further, an arbitrary combination of the above-mentioned components and converting the expression of the present invention into a method, an apparatus, a system, a recording medium, a computer program, and so on are also effective as the aspect of the present invention.

### ADVANTAGE OF THE INVENTION

According to the present invention, it is possible to effectively use an uplink channel corresponding to a downlink channel used for broadcasting.

### BRIEF DESCRIPTION OF THE DRAWINGS

FIG. 1 A view showing a configuration of a communication system according to an embodiment of the present invention.

FIG. 2(a) A view showing a frame configuration in the communication system of FIG. 1.

FIG. 2(b) A view showing a frame configuration in the communication system of FIG. 1.

FIG. 2(c) A view showing a frame configuration in the communication system of FIG. 1.

FIG. 3 A view showing an arrangement of a sub-channel in the communication system of FIG. 1.

FIG. 4 A view showing a configuration of the cell station of FIG. 1.

FIG. 5 A view showing an outline of sub-channel allocation by the cell station of FIG. 4.

FIG. 6 A view showing a configuration of the personal station of FIG. 1.

FIG. 7 A sequence diagram showing a communication sequence in the communication system of FIG. 1.

### DESCRIPTION OF REFERENCE NUMERALS AND SIGNS

10: cell station, 12: personal station, 14: network, 16: streaming server, 20: RF unit, 22: baseband processor, 24: modulator/demodulator, 26: IF unit, 28: radio controller, 30: storage, 32: control channel decision unit, 38: radio resource allocator, 50: RF unit, 52: modulator/demodulator, 54: IF unit, 56: display unit, 58: controller, 100: communication system

### BEST MODE FOR CARRYING OUT THE INVENTION

At first, before a concrete description of the present invention, an overview of the present invention will be described. Embodiments of the present invention are related to a communication system configured of a control station, a cell station, and personal stations. In the communication system, each frame is formed by time division multiplexing a plurality of time slots, and the each time slot is formed by frequency-division multiplexing a plurality of sub-channels. Further, each sub-channel is configured of a multi-carrier signal. Here, an OFDM signal is used as the multi-carrier signal, and an OFDMA is used as frequency division multiplexing. Meanwhile, hereinafter, a channel specified by the sub-channel and the time slot is referred to as “sub-channel block” or “burst,” and a signal arranged on the “sub-channel block” or “burst” is referred to as “burst signal.” The sub-channel (hereinafter, referred to as “control channel”) on which a control signal is arranged and the sub-channel on which a data signal is arranged are separately prescribed. For example, the control channel is arranged on the sub-channel having a lowest frequency in a frequency band prescribed by the communication system.

To perform data communication, the cell station allocates downlink bursts and uplink bursts to the personal stations so as to be equal in number. Meanwhile, the cell station holds the downlink bursts for the purpose of broadcasting, and broadcasts moving image data, etc., in the held downlink bursts. The numerous personal stations receive the broadcast moving image data to reproduce the moving image data. In the case where the downlink bursts and the uplink bursts, both of which are included in one frame, are equal in number, the presence of the downlink bursts used for the broadcasting causes the uplink bursts to be left behind, which is corresponding to the downlink bursts. To inhibit reduction in transmission efficiency caused by the presence of the uplink bursts, the communication system according to this embodiment perform the following process.

The cell station alternately allocates the mutually corresponding downlink bursts in each frame to the personal station and broadcasting channel. Here, the mutually corresponding downlink bursts is bursts that have the same sub-channel and time slot in each frame. Therefore, it is equivalent to performing communication at a half rate on the downlink for the personal station. Further, the broadcasting channel is a channel for broadcasting the above-mentioned moving image data etc. Meanwhile, the cell station allocates the uplink bursts, which corresponds to the downlink bursts, to only the above-mentioned personal station. Therefore, unlike the downlink, it is equivalent to performing communication at a full rate on an uplink for the personal station. In this way, by making a difference between the number of downlink bursts and the number of uplink bursts to be allocated to one personal station, the uplink bursts corresponding to the downlink bursts used for the broadcasting channel are effectively used.

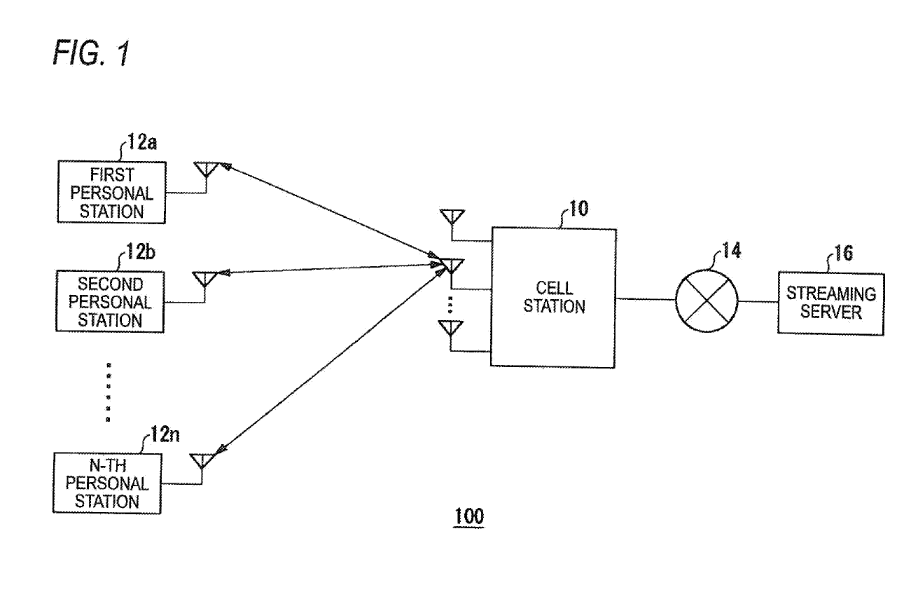

FIG. 1 shows configuration of a communication system 100 according to an embodiment of the present invention. The communication system 100 includes a cell station 10; a first personal station 12a, a second personal station 12b, an N-th personal station 12n, all of which are generically called as a personal station 12; a network 14; and a streaming server 16.

The cell station 10 is connected to the personal station 12 over a wireless network at one end thereof, and a wired network 14 at the other end thereof. The cell station 10 performs communication with the personal station 12 by allocating bursts to the personal station 12. In detail, the cell station 10 broadcasts a broadcast signal in the above-mentioned control channel, and the personal station 12 receives the broadcast signal, thereby recognizing the presence of the cell station 10. Afterwards, the personal station 12 transmits a request signal for location registration to the cell station 10. Further, the personal station 12 transmits a request signal for burst allocation to the cell station 10, and the cell station 10 allocates the bursts to the personal station 12 in response to the received request signal. Also, the cell station 10 transmits information about the bursts allocated to the personal station 12, and the personal station 12 performs communication with the cell station 10 using the allocated bursts.

As a result, the data transmitted from the personal station 12 is output to the network 14 via the cell station 10, and is finally received into communication devices (not shown) connected to the network 14. Further, the data is transmitted even in a direction from the communication device toward the personal station 12. Here, the communication system 100 corresponds to an orthogonal frequency division multiple access (OFDMA) system. OFDMA refers to technology that performs frequency multiplexing on a plurality of personal stations while using OFDM. In this OFDMA, a sub-channel is established by a plurality of sub-carriers, and a plurality of sub-channels is subjected to frequency-division multiplexing.

Further, a multi-carrier signal is divided into a plurality of time slots on a time axis by combination with time-division multiple access (TDMA). That is, each frame is formed by time-division multiplexing of the plurality of time slots, each of time slots is formed by frequency-division multiplexing of the plurality of sub-channels. Further, each sub-channel is formed by the multi-carrier signal. In the description above, the burst is specified by a combination of the sub-channel and the time slot.

The streaming server 16 is connected to the cell station 10 via the network 14. The streaming server 16 stores the moving image data. The streaming server 16 transmits the moving image data to the cell station 10 via the network 14. Further, the cell station 10 transmits the moving image data to the plurality of personal stations 12. Here, as described above, when the bursts are allocated to each personal station 12, many bursts are required for streaming of the moving image data. To enhance transmission efficiency, the cell station 10 according to this embodiment also allocates the downlink burst to a broadcasting channel. Further, the cell station 10 broadcasts the moving image data on the broadcasting channel. Further, the allocation of the bursts to the personal station 12 and the broadcasting channel will be described below.

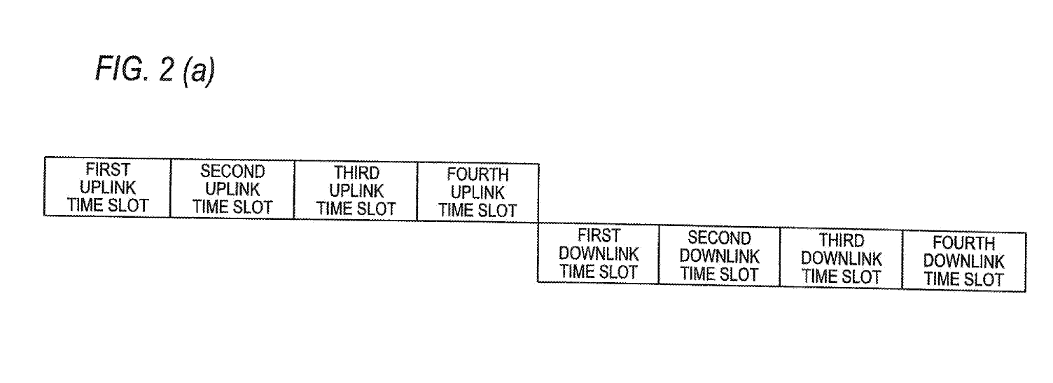

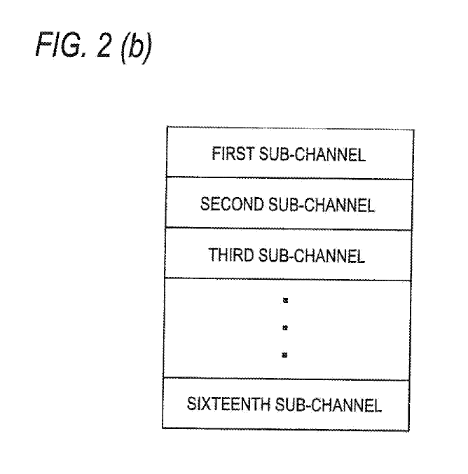

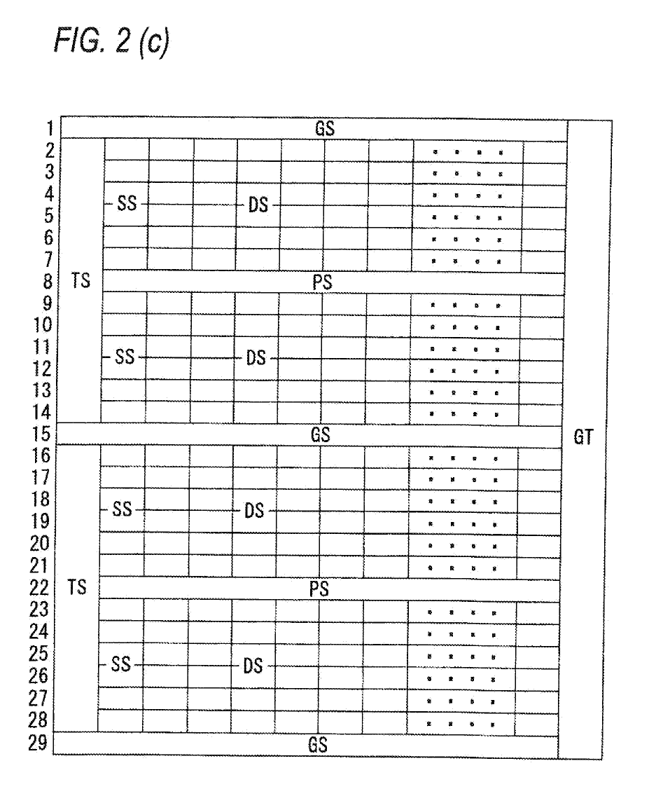

FIGS. 2(a) through 2(c) show a frame configuration in the communication system 100. In the figures, a horizontal direction corresponds to a time axis. A frame is established by time multiplexing of eight time slots. Further, the eight time slots are configured of four uplink time slots and four downlink time slots. Here, the four uplink time slots are represented from a “first uplink time slot” to a “fourth uplink time slot,” and the four downlink time slots are represented from a “first downlink time slot” to a “fourth downlink time slot.” Further, the shown frame is repeated continuously.

Further, the frame is not limited to the configuration as shown in FIG. 2(a), and may be configured of, for instance, four time slots or 16 time slots. However, to make the description clear, the frame will be described on the basis of the configuration as shown in FIG. 2(a). Further, to make the description concise, it is assumed that the uplink time slot has the same configuration as the downlink time slot. As such, although only one of the uplink time slot and the downlink time slot is described, this description is equally applied to the other time slot. Further, a super-frame is formed by sequence of the plurality of frame as shown in FIG. 2(a). Here, as an example, it is assumed that such the super-frame is formed by 20 frames.

FIG. 2(b) shows configuration of one of the time slots of FIG. 2(a). In the figure, a vertical direction corresponds to a frequency axis. As shown, one time slot is formed by frequency multiplexing of 16 sub-channels ranging from a “first sub-channel” to a “sixteenth sub-channel.” Further, these sub-channels are subjected to frequency-division multiplexing. Since each time slot is configured as in FIG. 2(b), the above-mentioned burst is specified by combination of the time slot and the sub-channel. Further, the frame corresponding to one among the sub-channels of FIG. 2(b) may be configured as shown in FIG. 2(a). Meanwhile, the number of sub-channels arranged on one time slot may not be sixteen. Here, it is assumed that the allocation of the sub-channel in the uplink time slot is basically identical to the allocation of the sub-channel in the downlink time slot. Further, it is assumed that at least one broadcast signal is allocated in unit of super-frame. For example, the broadcast signal is allocated to one sub-channel in one of a plurality of downlink time slots included in the super-frame.

FIG. 2(c) shows configuration of one of the sub-channels of FIG. 2(b). The sub-channel of FIG. 2(c) corresponds to the above-mentioned burst signal. As in FIG. 2(a) or 2(b), a horizontal direction in the figure corresponds to a time axis, and a vertical direction in the figure corresponds to a frequency axis. Further, numbers from “1” to “29” are added on the frequency axis, and these numbers represent the numbers of sub-carriers. In this manner, the sub-channel is configured by a multi-carrier signal, and specifically an OFDM signal. In the figure, “TS” corresponds to a training symbol, and is configured by a known value. Further, “SS” corresponds to a signal symbol. “GS” corresponds to a guard symbol, and substantial signal is not arranged on the GS. “Personal station” corresponds to a pilot symbol, and is configured by a known value. “DS” corresponds to a data symbol, and is data to be transmitted. “GT” corresponds to a guard time, and substantial signal is not arranged on the GT.

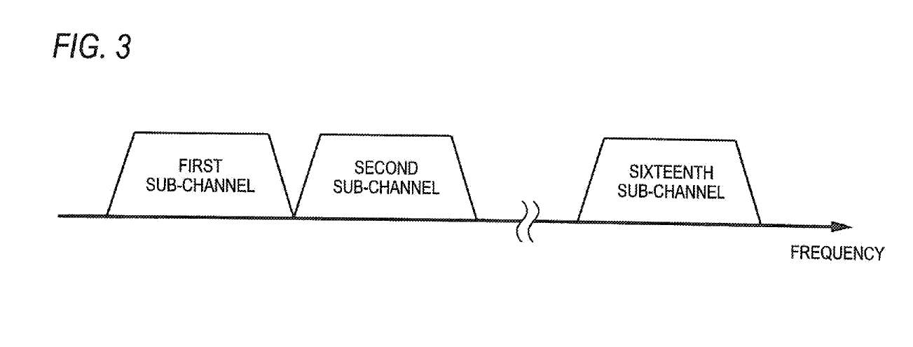

FIG. 3 shows arrangement of a sub-channel in the communication system 100. In FIG. 3, a horizontal axis represents a frequency axis, and a spectrum of the time slot shown in FIG. 2(b). As described above, the 16 sub-channels ranging from the first sub-channel to the sixteenth sub-channel are frequency-division multiplexed on one time slot. Each sub-channel is configured by a multi-carrier signal, specifically the OFDM signal.

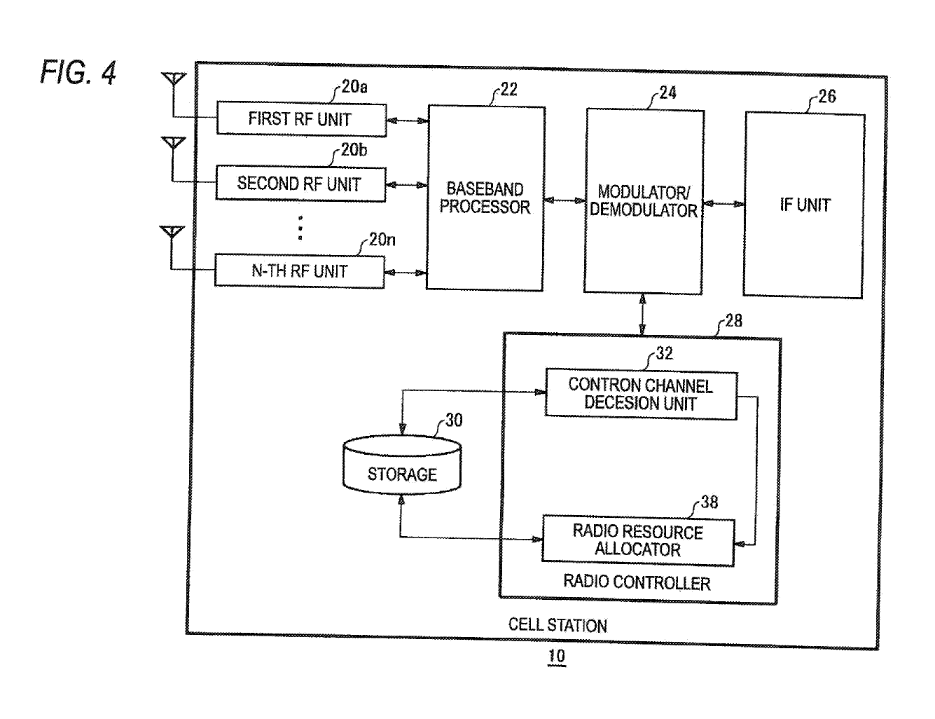

FIG. 4 shows configuration of a cell station 10. The cell station 10 includes a first radio frequency (RF) unit 20a, a second RF unit 20b, an N-th RF unit 20n, all of which are generically called as a RF unit 20; a baseband processor 22, a modulator/demodulator 24, an intermediate frequency (IF) unit 26, a radio controller 28, and a storage 30. Further, the radio controller 28 includes a control channel decision unit 32 and a radio resource allocator 38.

The RF unit 20 performs frequency conversion on a radio frequency multi-carrier signal received from the personal station 12 (not shown), and generates a baseband multi-carrier signal, as a receiving processing. Here, the multi-carrier signal is formed as in FIG. 3, and corresponds to the uplink time slot of FIG. 2(a). Further, the RF unit 20 outputs the baseband of multi-carrier signal to the baseband processor 22. In general, since the baseband of multi-carrier signal is formed by an in-phase component and an orthogonal component, it should be transmitted by two signal lines. But, for clarity in the figure, it is assumed that only one signal is shown. Further, the RF unit 20 includes an AGC or an A/D converter.

The RF unit 20 performs frequency conversion on the baseband multi-carrier signal received from the baseband processor 22, and generates a radio frequency multi-carrier signal, as a transmission processing. Further, the RF unit 20 transmits the radio frequency multi-carrier signal. Meanwhile, the RF unit 20 transmits the multi-carrier signal while using the same radio frequency band as the received multi-carrier signal. That is, as in FIG. 2(a), it is assumed that time division duplex (TDD) is used. Further, the RF unit 20 also includes a power amplifier (PA) and a D/A converter.

The baseband processor 22 receives the baseband multi-carrier signal from each of the plurality of RF units 20, as the receiving processing. Since the baseband multi-carrier signal is the signal of a time domain, the baseband processor 22 converts the time-domain signal into the signal of a frequency domain by means of FFT, and performs adaptive array signaling on the frequency-domain signal. Further, the baseband processor 22 performs timing synchronization, i.e. setting of a window of FFT, as well as deletion of a guard interval. Since a known technique may be used for such timing synchronization, etc., description thereof is skipped herein. The baseband processor 22 outputs the result of processing of the adaptive array signaling to the modulator/demodulator 24.

The baseband processor 22 receives the frequency-domain multi-carrier signal from the modulator/demodulator 24, and performs a distribution processing based on a weight vector, as the transmission processing. The baseband processor 22 converts the frequency-domain signal into a time-domain signal by means of IFET with respect to the frequency-domain multi-carrier signal received from the modulator/demodulator 24, and outputs the converted time-domain signal to the RF unit 20, as transmission processing. Further, the baseband processor 22 performs addition of a guard interval, but the addition of the guard interval is not described herein. Here, the frequency-domain signal includes a plurality of sub-channels as in FIG. 2(b), and each sub-channel includes a plurality of sub-carriers as in the vertical direction of FIG. 2(c). For clarity in the figure, it is assumed that the frequency-region signal is arranged in the sequence of sub-carrier numbers and forms a serial signal.

The modulator/demodulator 24 demodulates the frequency-domain multi-carrier signal from the baseband processor 22, as the receiving process. The multi-carrier signal converted into the frequency-domain multi-carrier signal has a component corresponding to each of the plurality of sub-carriers as in FIG. 2(b) or 2(c). The modulator/demodulator 24 outputs the demodulated signal to the IF unit 26. Further, the modulator/demodulator 24 performs modulation as the transmission processing. The modulator/demodulator 24 outputs the modulated signal as the frequency-domain multi-carrier signal to the baseband processor 22.

The IF unit 26 receives the demodulated result from the modulator/demodulator 24 and splits the demodulated result in unit of the personal station 12, as receiving processing. That is, the demodulated result is configured by the plurality of sub-channels as in FIG. 3. As such, in the case where one sub-channel is allocated to one personal station 12, signals from the plurality of personal stations 12 are included in the demodulated result. The IF unit 26 splits this demodulated result in unit of the personal station 12. The IF unit 26 outputs the split demodulated result to the network 14. Then, the IF unit 26 performs the transmission according to information for identifying a receiving destination such as an internet protocol (IP) address.

Further, the IF unit 26 receives data for the plurality of personal stations 12 via the network 14 (not shown), as the transmission processing. The IF unit 26 allocates the data to the sub-channels, and forms a multi-carrier signal from the plurality of sub-channels. That is, the IF unit 26 forms the multi-carrier signal configured by the plurality of sub-channels as in FIG. 3. Further, it is assumed that the sub-channels to which the data is to be allocated are previously decided as in FIG. 2(c), and that instruction associated with the decision is received from the radio controller 28. The IF unit 26 outputs the multi-carrier signal to the modulator/demodulator 24.

The radio controller 28 controls operation of the cell station 10. The radio controller 28 prescribes the time slot formed by the frequency multiplexing of the plurality of sub-channels and the frame formed by time multiplexing of the plurality of time slots, as in FIGS. 2(a) through 2(c) and FIG. 3. Further, the radio controller 28 may instructs the modulator/demodulator 24, etc. to form a burst signal, and may broadcasts a broadcast signal from the modulator/demodulator 24 via the RF unit 20. The control channel decision unit 32 allocates the broadcast signal to the sub-channel corresponding to a control channel. Here, the broadcast signal refers to a signal in which information used to control communication with the personal station 12 is included. The importance of this broadcast signal may be higher than a packet signal in which data is included. The control channel decision unit 32 selects a pre-decided sub-channel with reference to the storage 30. Further, the control channel decision unit 32 notifies the selected sub-channel to the radio resource allocator 38.

The radio resource allocator 38 allocates the broadcast signal to the control channel in according to the notification from the control channel decision unit 32. The storage 30, which cooperates with the radio controller 28, store such as information about the sub-channels allocated to the personal stations 12 and information about the control channel. Further, after the transmission of the broadcast signal, the radio resource allocator 38 receives such as a request for location registration and a request for burst allocation of the personal station 12 (not shown) from the RF unit 20 via the modulator/demodulator 24. Meanwhile, before the request for burst allocation is received, ranging processing is performed between the cell station 10 and the personal station 12, but description thereof is skipped herein. The request for burst allocation is called a request for radio resource acquisition. The radio resource allocator 38 allocates the sub-channel to the personal station 12 receiving the request for the allocation.

The radio resource allocator 38 allocates the broadcasting channel and the personal station 12 with switching to mutually corresponding downlink time slots in each frame. For example, the radio resource allocator 38 alternately allocates the broadcasting channel and the personal station 12 in unit of frame in each frame to bursts, which are specified by a second sub-channel and a second downlink time slot. In detail, in the odd frame, the bursts specified by the second sub-channel and the second downlink time slot are allocated to the broadcasting channel. In contrast, in the even frame, the bursts specified by the second sub-channel and the second downlink time slot are allocated to the personal station 12. As a result, a half rate status is realized for the personal station 12 on the downlink.

The radio resource allocator 38 allocates personal station 12 to an uplink time slot that corresponds to the downlink time slot allocated to the broadcasting channel and an uplink time slot that corresponds to the downlink time slot allocated to the personal station 12. That is, the radio resource allocator 38 allocates the personal station 12 to the bursts that are specified by a second sub-channel and a second uplink time slot in all the frames. In other words, regardless of the sequence of the frames, the bursts specified by the second sub-channel and the second uplink time slot are allocated to the personal station 12. As a result, a full rate status is realized for the personal station 12 on the uplink. The radio resource allocator 38 makes the number of downlink bursts allocated to the personal station 12 different from the number of uplink bursts allocated to the personal station 12 in two continuous frames. In particular, the latter becomes larger than the former.

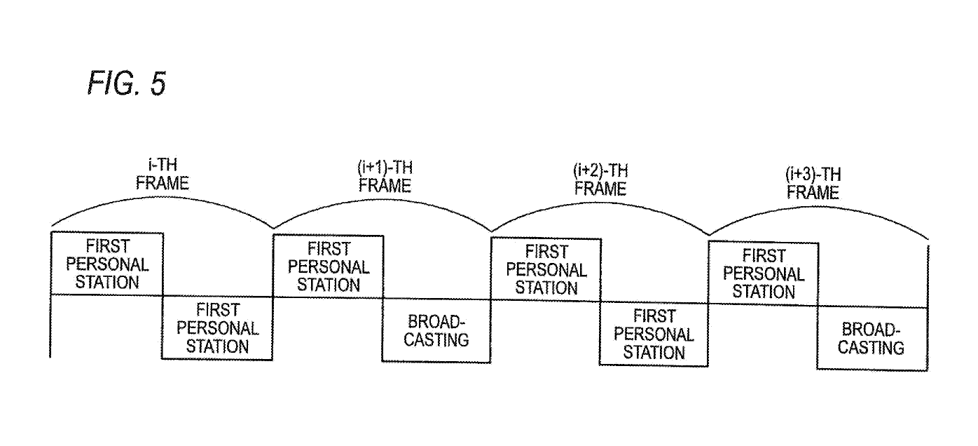

FIG. 5 shows an outline of sub-channel allocation by a cell station 10. FIG. 5 shows only the bursts specified by the predetermined time slot of the plurality of time slots shown in FIG. 2(a) and the predetermined sub-channel of the plurality of sub-channels shown in FIG. 2(b). Here, as described above, in one frame, the bursts specified by the second sub-channel and the second uplink time slot and specified by the second sub-channel and the second downlink time slot are shown. Further, like FIG. 2(a), the uplink time slot is shown on the upper side of the frame, and the downlink time slot is shown on the lower side of the frame. Further, a plurality of frames, for instance, from an i-th frame to an (i+3)-th frame are shown. In the i-th frame, the uplink bursts and the downlink bursts are allocated together to the first personal station 12a. Further, in the next (i+1)-th frame, the uplink bursts are allocated to the first personal station 12a, on the other hand, the downlink bursts are allocated to the broadcasting channel. Further, the allocation in the (i+2)-th frame is identical to that in the i-th frame, and the allocation in the (i+3)-th frame is identical to that in the (i+1)-th frame. Return to FIG. 4.

The radio resource allocator 38, for instance in two continuous frames, may control a communication speed in the downlink and a communication speed in the uplink for the personal station 12 based on both the number of downlink bursts and the number of uplink bursts allocated to the personal station 12 in a predetermined period of time. Here, since a ratio of the number of downlink bursts to the number of uplink bursts is 1:2, the radio controller 28 controls the communication speed such that a ratio of the communication speed in the downlink to the communication speed in the uplink is 2:1. Meanwhile, the communication speed is specified by a modulation method, an encoding ratio of error correction, and a combination thereof. Further, an entire communication speed for the personal station 12 is derived by a product of the communication speed and the burst number.

Therefore, by a relationship between the burst number and the communication speed as described above, the entire communication speed can be equaled in the uplink and downlink, even when the number of uplink bursts is different from the number of downlink bursts. Further, a characteristic of the PA installed on the personal station 12 is generally inferior to a characteristic of the PA installed on the cell station 10. Thus, transmission power in the uplink is less than transmission power in the downlink, so that a quality of the uplink is generally worse than a quality in the downlink. The radio resource allocator 38 makes the communication speed in the uplink slower than that in the downlink, so that it can approximate the qualities of the uplink and downlink. The IF unit 26, the modulator/demodulator 24, the baseband processor 22, and the RF unit 20 transmit the broadcasting signal and the downlink burst signal direct to the personal station 12, and receive the uplink burst signal from the personal station 12.

When the radio resource allocator 38 performs the allocation as described above, the baseband processor 22 performs a directivity control, i.e. adaptive array signal processing as follows. The baseband processor 22 performs a common directivity control on the uplink burst signal corresponding to the downlink bursts allocated to the personal station 12 and the uplink burst signal corresponding to the downlink bursts allocated to the broadcasting channel. For example, the common directivity control is a control based on an adaptive algorithm. The directivity control is performed on the downlink burst signal allocated to the personal station 12. Meanwhile, another directivity control, for instance a non-directivity control, is performed on the downlink burst signal allocated to the broadcasting channel. Thereby, a communication target is allowed to correspond to the directivity control.

This configuration is realized in hardware by a CPU, memory, other LSIs of an arbitrary computer, and in software by a program including a communication function, etc., loaded on the memory. However, here, the functional blocks realized by cooperation of the hardware and the software are shown. Thus, it will be understood by those skilled in the art that the functional blocks are realized in various types by only the hardware, only the software, and a combination thereof.

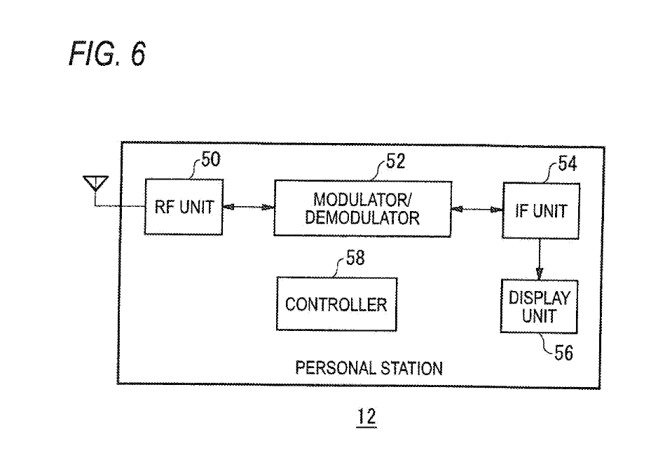

FIG. 6 shows configuration of a personal station 12. The personal station 12 includes a RF unit 50, a modulator/demodulator 52, an IF unit 54, a display unit 56, and a controller 58.

The RF unit 50 performs processing corresponding to the RF unit 20 of FIG. 4, and the modulator/demodulator 52 performs processing adding FFT and IFFT to the modulator/demodulator 24 of FIG. 4. Therefore, here, a description of the RF unit 50 and the modulator/demodulator 52 is skipped. The IF unit 54 has a function of interface with a user. For example, the IF unit 54 includes a button, etc., thereby receiving an instruction from the user. Further, the IF unit 54 outputs the received instruction as a signal to the modulator/demodulator 52 or the controller 58. The display unit 56 includes a display, and displays data demodulated by the modulator/demodulator 52. In particular, the display unit 56 reproduces and displays the moving image data.

The controller 58 controls entire operation of the personal station 12. The controller 58 operates the RF unit 50, the modulator/demodulator 52, and the IF unit 54 so as to transmit and receive bursts allocated to the cell station 10 and a burst signal in the broadcasting channel. As described above, when the number of uplink bursts is different from the number of downlink bursts, and when the broadcasting channel exists, the controller 58 performs operation corresponding to the operation at the cell station 10.

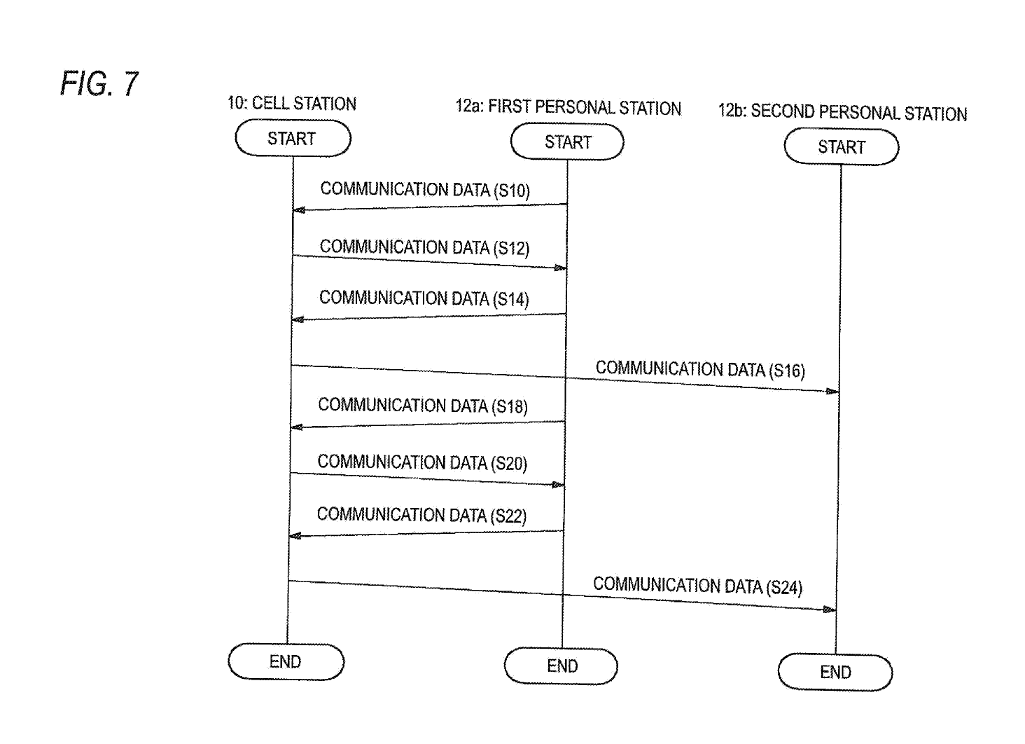

The operation of the communication system 100 having the above-mentioned configuration will be described. FIG. 7 is a sequence diagram showing a communication sequence in the cell station 10. Here, it is assumed that the first personal station 12a communicates with the cell station 10, and the second personal station 12b receives a broadcasting channel from the cell station 10. The first personal station 12a transmits communication data to the cell station 10 (S10), and the cell station 10 transmits communication data to the first personal station 12a (S12). The first personal station 12a transmits communication data to the cell station 10 (S14), and the cell station 10 transmits data arranged on the broadcasting channel (hereinafter, referred to as “broadcasting data”) to the second personal station 12b (S16). The first personal station 12a transmits communication data to the cell station 10 (S18), and the cell station 10 transmits communication data to the first personal station 12a (S20). The first personal station 12a transmits communication data to the cell station 10 (S22), and the cell station 10 transmits broadcasting data to the second personal station 12b (S24).

According to embodiments of the present invention, the broadcasting channel and the personal station are alternately allocated in the downlink, and the personal station is allocated in the uplink, so that the uplink channel corresponding to the broadcasting channel can be effectively used. Further, since the personal station is operated at a half rate in the downlink and the personal station is operated at a full rate in the uplink, the processing can be easily carried out. Also, since the broadcasting channel is allocated to the downlink, the moving image data can be broadcast to the plurality of personal stations. Further, since the communication speed is controlled based on the number of allocated bursts, the entire communication speeds of the uplink and downlink can be approximated to each other although the number of allocated bursts in the uplink is different from the number of allocated bursts in the downlink. In addition, the communication speed in the downlink is slower than that in the uplink, so that the communication qualities of the uplink and downlink can be approximated to each other.

The present invention has been described on the basis of the above-mentioned embodiments. These embodiments are illustrative, and it will be understood by those skilled in the art that various modifications can be made by combination of components and processing processes of the embodiments, and that such modification fall within the scope of the present invention.

In the embodiments of the present invention, the radio resource allocator 38 alternately allocates the relatively corresponding bursts, which are included in each frame, to the broadcasting channel and one personal station 12. However, the radio resource allocator is not limited to this configuration. For example, the number of personal stations 12 may be not only one also two or more. If the number of personal stations 12 is three, the allocation of the bursts in the downlink corresponds to a quarter-rate. Then, the uplink bursts corresponding to the broadcasting channel may be fixed to one of the three personal stations 12 when allocated. Otherwise, the uplink bursts may be alternately allocated to the three personal stations 12. According to this modification, it is possible to flexibly control the communication speeds of the personal station 12 and the broadcasting channel.

Although the present invention has been described in detail or with reference to specific embodiments thereof, it is apparent to those skilled in the art that a variety of modifications and variations may be made to the present invention without departing from the spirit and scope of the present invention.

The present application is based on Japanese Patent Application No. 2008-056687 filed on Mar. 6, 2008, the contents of which are herein incorporated by reference.

### INDUSTRIAL APPLICABILITY

According to the present invention, it is possible to effectively use the uplink channel corresponding to the downlink channel used for broadcasting.

1. A cell station comprising:
an allocation unit, which prescribes repetition of a frame formed by a plurality of downlink time slots and a plurality of uplink time slots, and which allocates a first data to be broadcast and a second data to be transmitted to a personal station with switching to the downlink time slots corresponding to each other in each frame; and
a communication unit that transmits the first and second data allocated by the allocation unit,
wherein the allocation unit allocates a third data, which to be received from the personal station, to the uplink time slot corresponding to the downlink time slot allocated to the first data and to the uplink time slot corresponding to the downlink time slot allocated to the second data, and
wherein the communication unit receives the third data allocated by the allocation unit.

2. The cell station according to claim 1, wherein the communication unit controls a communication speed for the second data and a communication speed for the third data based on a number of the downlink time slots allocated to the second data by the allocation unit in a predetermined period and a number of the uplink time slots allocated to third data by the allocation unit in a predetermined period.

3. The cell station according to claim 1, wherein the communication unit performs a common directivity control on the third data, which is allocated to the uplink time slot corresponding to the downlink time slot allocated to the first data, and on the first data, which is allocated to the uplink time slot corresponding to the downlink time slot allocated to the second data.

4. The cell station according to any one of claim 1,
wherein the first data is broadcasting data, and
wherein the second and third data are communication data.

5. A communication method comprising:
a step of prescribing repetition of a frame formed by a plurality of downlink time slots and a plurality of uplink time slots, and allocating a first data to be broadcast and a second data to be transmitted to a personal station with switching to the downlink time slots corresponding to each other in each frame;
a step of transmitting the allocated first and second data;
a step of allocating a third data, which to be received from the personal station, to the uplink time slot corresponding to the downlink time slot allocated to the first data and to the uplink time slot corresponding to the downlink time slot allocated to the second data; and a step of receiving the allocated third data.
